(19) United States
(12) Patent Application Publication
(10) Pub. No.: US 2024/0226793 A9
(43) Pub. Date: Jul. 11, 2024

(54) AN AIR FILTER ASSEMBLY AND A METHOD THEREOF

(71) Applicant: TAD AIRCON PRIVATE LIMITED, UDUPI (IN)

(72) Inventor: ADRIAN MELROY CORNELEO, UDUPI (IN)

(21) Appl. No.: 18/548,500

(22) PCT Filed: Mar. 15, 2022
(86) PCT No.: PCT/IB2022/052308

§ 371 Date: Sep. 1, 2023

(30) Foreign Application Priority Data
Mar. 17, 2021 (IN) 202141011353

(51) Int. Cl. B01D 46/121; B01D 39/06; B01D 46/00

(52) U.S. Cl. CPC B01D 46/121; B01D 39/06; B01D 46/0038; B01D 2239/065; B01D 2253/102; B01D 2257/708; B01D 2257/90; B01D 2258/06

(57) ABSTRACT

An air filter assembly 10 is disclosed. The assembly includes a filter frame 60 including at least one of a sigma ‘Σ’ convex shape and a V-convex shape and configured to accommodate at least two frames, using frame on frame design, to achieve maximum surface area, minimum air pressure drop, minimum filter rack material and save installation space. The filter frame includes at least three stage filter media 30 including a pre-filter 40 configured to filter coarse dust particles of a predefined size. The at least three stage filter media include a carbon filter 50 configured to eliminate formaldehyde, odors and volatile organic compounds in the air and improve air quality suitable for breathing. The at least three stage filter media include a fine filter 60 configured to remove bacteria, pollen, fine dust and aerosol of predetermined size from the air. The assembly includes a filter rack 70 configured to accommodate a predefined number of filter frames to overcome expected deflection of the at least three stage filter media.

### CROSS-REFERENCE TO RELATED APPLICATION

This application claims priority from a patent application filed in India having Patent Application No. 202141011353, filed on Mar. 17, 2021, and titled “AN AIR FILTER ASSEMBLY AND A METHOD THEREOF” and a PCT Application No. PCT/IB2022/052308 filed on Mar. 15, 2022, and titled “AN AIR FILTER ASSEMBLY AND A METHOD THEREOF.”

### FIELD OF INVENTION

Embodiments of the present disclosure relate to mechanical air conditioning system and more particularly to an air filter assembly and a method thereof.

### BACKGROUND

In heating, ventilating, and air conditioning systems (HVAC systems), and more specifically in variable air volume (VAV) HVAC systems, medium and high efficiency air filters are used. Generally high efficiency long life particulate filtration is commonly desired in home, vehicle, office, health care, or critical manufacturing environments. With these uses frequent filter changeout is costly and/or sometimes missed. Currently, recirculating air handling units working in most of the commercial, office building are with single stage low efficiency (MERV-8 or G4 as per EU standard). However, such units may not capture any of 0.3 μm particle size such as bacteria, pollen, virus and fine dust in the recirculating air.

Currently installed air filters and filter rack assembly mounted on a sliding rail that does not guaranty on filter bypass air leak, more specifically, part of the air may not pass through the filter media and directly pass to the air conditioned space. If these filter efficiencies are upgraded (to fine/bag type filters), it will affect unit base frame length by more than 500 mm which further results in no space for installation on existing unit. If panel type high efficiency fine filters are used, it will result in a no adequate air flow and cooling on a premise.

Hence, there is a need for an improved air filter assembly to address the aforementioned issue(s).

### BRIEF DESCRIPTION

In accordance with an embodiment of the present disclosure, an air filter assembly is provided. The assembly includes a filter frame including at least one of a sigma ‘Σ’ convex shape and a V-convex shape. The filter frame is configured to achieve maximum surface area and minimum air pressure drop. The filter frame includes at least three stage filter media including a pre-filter configured to filter coarse dust particles of a predefined size. The at least three stage filter media include a carbon filter configured to eliminate formaldehyde, odors and volatile organic compounds in the air and improve air quality suitable for breathing. The at least three stage filter media include a fine filter configured to remove bacteria, pollen, fine dust and aerosol of predetermined size from the air, where each of the at least three stage filter media include the at least one of a sigma convex shape and a V-convex shape. The assembly includes a filter rack configured to accommodate a predefined number of filter frame to overcome expected deflection of the at least three stage filter media.

In accordance with another embodiment of the present disclosure, a method to assemble an air filter assembly is provided. The method includes providing a filter frame including at least one of a sigma ‘Σ’ convex shape and a V-convex shape, where providing a filter frame comprises achieving maximum surface area and minimum air pressure drop. The method also includes accommodating at least three stage filter media inside the filter frame. The method further includes accommodating the at least three stage filter media comprising providing a pre-filter to filter coarse dust particles of a predefined size. The method further includes accommodating the at least three stage filter media comprising providing a carbon filter to eliminates formaldehyde, odors and volatile organic compounds in the air and improve air quality suitable for breathing. The method further includes accommodating the at least three stage filter media comprising providing a fine filter to remove bacteria, pollen, fine dust and aerosol of predetermined size from the air. The method further includes accommodating a predefined number of filter frame in a filter rack to overcome expected deflection of the at least three stage filter media.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of air filter assembly with filter frame on frame arrangement in accordance with an embodiment of the present disclosure;

FIG. 2 is a schematic representation of at least three stage filter media of air filter assembly in accordance with an embodiment of the present disclosure;

FIG. 3 is a schematic representation of filter rack of the air filter assembly in accordance with an embodiment of the present disclosure;

FIG. 4 is a schematic representation of back isometric 3D view of each filter media of air filter assembly in accordance with an embodiment of the present disclosure;

FIG. 5 is a schematic representation of side view and top view of the filter media respectively in accordance with an embodiment of the present disclosure; and

FIG. 6 is a flow chart representing the steps involved in a method to assemble air filter assembly in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DETAILED DESCRIPTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present disclosure will be described below in detail with reference to the accompanying figures.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to an air filter assembly and a method thereof. As used herein, the air filter assembly cleans the air that circulates through a heating and cooling system. The air filter assembly trap and hold many types of particulates and contaminants that could affect health and comfort of many people. In one embodiment, the air filter assembly is used for HVAC systems. As used herein, HVAC (heating, ventilation, and air conditioning) is the technology of indoor and vehicular environmental comfort. Its goal is to provide thermal comfort and acceptable indoor air quality.

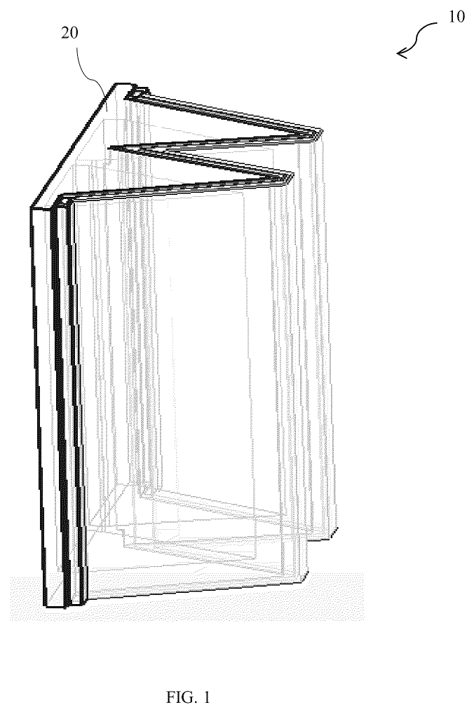

FIG. 1 is a schematic representation of air filter assembly 10 in accordance with an embodiment of the present disclosure. The assembly 10 includes a filter frame 20 including at least one of a sigma ‘Σ’ convex shape and a V-convex shape. In one embodiment, the filter frame 20 may be in a shape of convex sigma or M-shape or a zigzag shape. In another embodiment, the filter frame 20 may include a multiple V convex shapes to produce sigma shape. In one embodiment, the filter frame 20 is composed of a material comprising Plastic, Aluminum or pre-painted galvanized iron (PPGI). As used herein, PPGI refers to factory pre-painted zinc coated steel, where the steel is painted before forming, as opposed to post painting which occurs after forming. The filter frame 20 is configured to achieve maximum surface area and minimum air pressure drop. In a specific embodiment, the filter frame 20 is an air bypass leak proof frame. The filter frame design should be cost effective and material should be reusable and hygienic type. The filter frame 20 should be reusable to be sustainable and avoid material waste.

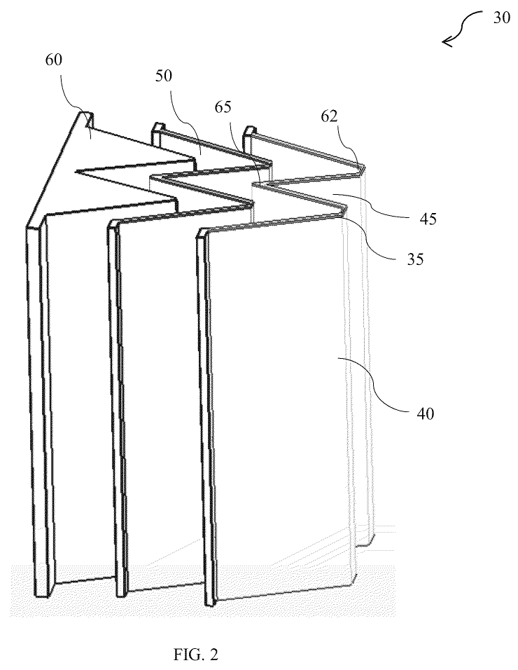

Referring to FIG. 2, there shown is that the filter frame 20 includes at least three stage filter media 30. The at least three stage filter media 30 include a pre-filter 40 which is configured to filter coarse dust particles of a predefined size. In an exemplary embodiment, the average life of fine of pre-filter media is 2 years. The pre-filter is a washable media with MERV-8 rating and suitable to arrest coarse dust particle 10-3 μm, with an average efficiency 84.9%. The dust from the pre-filter may be removed by washing it in clean water. The pre-filter 40 protects a carbon filter and a fine filter from early clogging. In a specific embodiment, the pre-filter 40 includes at least one of a series of MERV-8 class air filters.

Furthermore, the at least three stage filter media 30 include the carbon filter 50 which is configured to eliminate formaldehyde, odors and volatile organic compounds in the air and improve air quality suitable for breathing. In an exemplary embodiment, the average filter media life of the carbon filter 50 is 3-6 months. The carbon filter 50 uses a bed of activated carbon to remove impurities from a fluid using adsorption, where pollutants in the fluid to be treated are trapped inside the pore structure of a carbon substrate. The substrate is made of many carbon granules, each of which is itself highly porous. As a result, the substrate has a large surface area within which contaminants may be trapped.

Moreover, the at least three stage filter media 30 include a fine filter 60 which is configured to remove bacteria, pollen, fine dust and aerosol of predetermined size from the air. In an exemplary embodiment, the average filter media life of the fine filter is 6-months. Based on the indoor air quality requirement and air volume MERV-13 to 15 filter will be selected. This range of filter may remove 0.3-1.0 μm bacteria, pollen, fine dust and aerosol (virus) with an average efficiency 75% from the air.

Each of the at least three stage filter media 30 include the at least one of a sigma convex shape and a V-convex shape. In one embodiment, the at least three stage filter media 30 is formed in sigma or V-shape by folding so as to create mountain folds 35 and valley folds 45 at equal intervals and is held in the filter frame with the shape maintained. More specifically, the filter media 30 is folded so as to create mountain folds and valley folds mutually and is designed to make pressed projections 55 on surfaces, which face each other when the filter media 30 is folded, into contact with each other and maintain the interval between opposed surfaces of the filter media 30. Here, a pressed projection which is projected to the front side from one surface of the filter media 30 is referred to as a convex projection 62, and a pressed projection which is projected to the opposite side is referred to as a concave projection 65. That is, a concave projection viewed from one surface of the filter media 30 becomes a convex projection when viewed from the other surface. The filter media holding frame ensures minimum air pressure drop. Hence, the sigma “Σ” convex shape is used to increase surface area and achieve low air pressure drop. The filter media will go through a considerable amount of deflection since air pressure drop will be more than 0.5″ WG and may deflect the filter media and filter frame. The filter media should be fixed adherent to overcome the expected deflection.

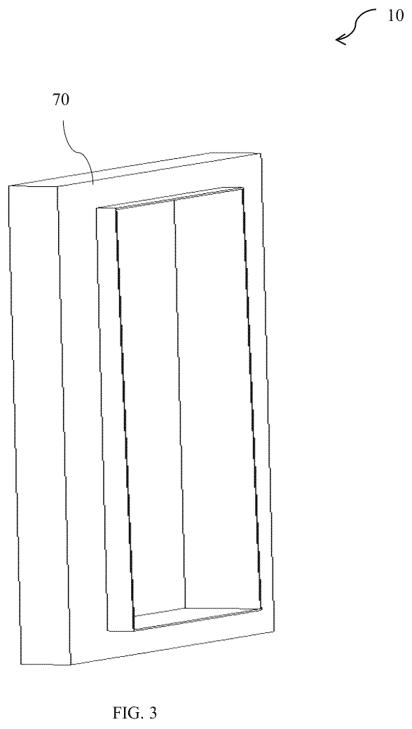

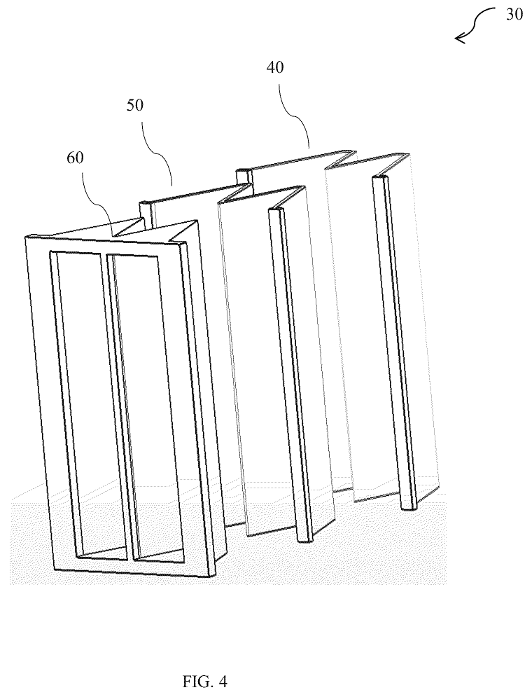

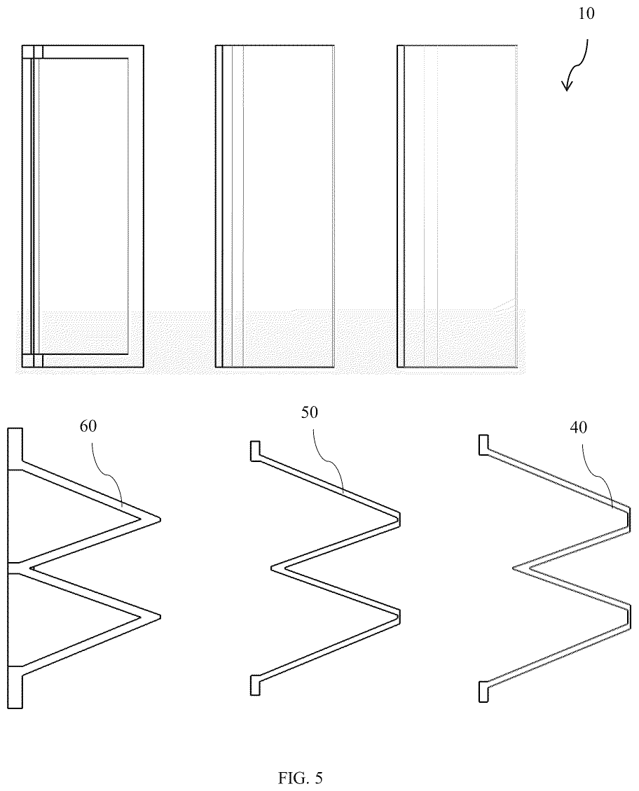

Referring to FIG. 3, there is shown that the assembly 10 includes a filter rack 70 configured to accommodate a predefined number of filter frame 20 to overcome expected deflection of the at least three stage filter media 30. More specifically, the filter rack 70 is specially designed to hold these frames in frame filters with multiple frames. In one embodiment, the filter rack 70 includes a plurality of mechanical clamps (not shown in FIG. 3) which are simple turn-key type, where the plurality of mechanical clamps is easily removed and re-fixed. The fixing procedure allows to remove one filter among the other filters without disturbing other filters. In a specific embodiment, the fine filter is adhered using a chemical adhesive and a plurality of mechanical clamps to withstand high air resistance. Various views of the air filter assembly 10 are shown in FIGS. 4 and 5.

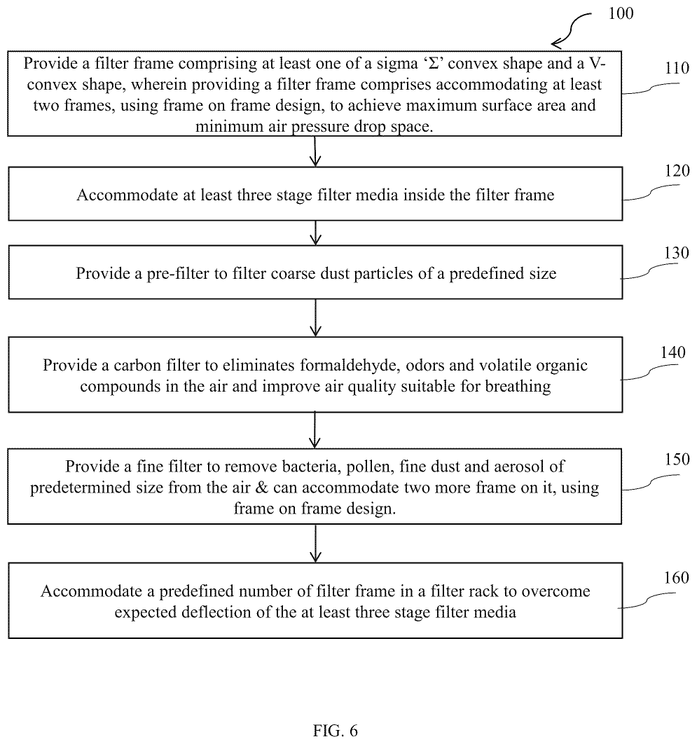

FIG. 6 is a flow chart representing the steps involved in a method 100 to assemble air filter assembly in accordance with an embodiment of the present disclosure. The method 100 includes providing a filter frame including at least one of a sigma ‘Σ’ convex shape and a V-convex shape, where providing a filter frame comprises achieving maximum surface area and minimum air pressure drop in step 110. In one embodiment, the filter frame is composed of a material comprising Plastic, Aluminum or pre-painted galvanized iron (PPGI). In a specific embodiment, the filter frame is an air bypass leak proof frame.

The method 100 also includes accommodating at least three stage filter media inside the filter frame in step 120. The method 100 further includes accommodating the at least three stage filter media comprising providing a pre-filter to filter coarse dust particles of a predefined size in step 130. In one embodiment, the pre-filter includes at least one of a series of MERV-8 or G4 class air filters.

The method 100 further includes accommodating the at least three stage filter media comprising providing a carbon filter to eliminates formaldehyde, odors and volatile organic compounds in the air and improve air quality suitable for breathing in step 140. The carbon filter uses a bed of activated carbon to remove impurities from a fluid using adsorption, where pollutants in the fluid to be treated are trapped inside the pore structure of a carbon substrate.

The method 100 further includes accommodating the at least three stage filter media comprising providing a fine filter to remove bacteria, pollen, fine dust and aerosol of predetermined size from the air in step 150. In one embodiment, the fine filter is adhered using a chemical adhesive and a plurality of mechanical clamps to withstand high air resistance. Based on the indoor air quality requirement and air volume MERV-13 to 15 filter will be selected. This range of filter may remove 0.3-1.0 μm bacteria, pollen, fine dust and aerosol (virus) with an average efficiency 75% from the air.

In one embodiment, accommodating at least three stage filter media inside the filter frame includes the at least one of a sigma convex shape and a V-convex shape of each of the at least three stage filter media. In such an embodiment, the sigma convex shape is obtained by folding so as to create mountain folds and valley folds to lock the at least tree stage filter media with each other.

The method 100 further includes accommodating a predefined number of filter frame in a filter rack to overcome expected deflection of the at least three stage filter media in step 160. In one embodiment, the filter rack may include a plurality of mechanical clamps having a turn-key. The plurality of clamps is configured to remove or fix the pre-filter without disturbing a filter from the at least three stage filter media.

Various embodiments of the air filter assembly as described above enables a special sigma “Σ” shape or V-shape air filter media holding frame with frame on frame design to integrate 3 independent filters on a single filter rack, along with filter rack design to hold multiple filters on a single rack. Similarly, inverse concave arrangement is possible to save space and material with first filter to air flow as pre-filter, second filter would be carbon filter and final filter will be a fine filter.

The filter media holding frame is the key component to ensure minimum air pressure drop. Hence a unique “Σ” convex shape is used to increase surface area and achieve low air pressure drop. This design provides solution to upgrade filters on existing air handling units and compact design solution for new installations. The assembly saves electric motor power by reducing filter air resistance with higher surface area. This filter frame reduces 25% of unit footprint with improved air filtration. The filter assembly provides compact footprint by reducing equipment room size and saves nature.

The filter rack air bypass factor is almost eliminated by proposed filter rack. The filter media frame design should be cost effective. The material should be reusable and hygienic type. The filter media frame should be reusable to be sustainable and avoid material waste. Further, air pass through the excising panel filter with less than 0.25″ WG resistance (Air pressure drop), hence there is no major bending or deflection of filter media. As opposed to proposed high efficiency filter will go through a considerable amount of deflection since Air pressure drop will be more than 0.5″ WG and may deflect the filter media and filter frame. Filter media should be fixed adherent to overcome the expected deflection.

The filter changing should not need specially trained technicians as it provides easy removing and re-fixing. The filter should create low pressure drop on air steam such that existing fan can handle it without major modification. With the filter medium for an air filter and the air filter unit provided with the filter medium, it is possible to suppress pressure loss at an air filter unit without increasing weight of the air filter unit.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. An air filter assembly comprising:
a filter frame comprising at least one of a sigma ‘Σ’ convex shape and a V-convex shape, wherein the filter frame is configured to accommodate at least two frames, using frame on frame design, to achieve maximum surface area and minimum air pressure drop,
wherein the filter frame comprises at least three stage filter media comprising:
a pre-filter configured to filter coarse dust particles of a predefined size;
a carbon filter configured to eliminate formaldehyde, odors and volatile organic compounds in the air and improve air quality suitable for breathing;
a fine filter configured to remove bacteria, pollen, fine dust and aerosol of predetermined size from the air,
wherein each of the at least three stage filter media comprises the at least one of a sigma convex shape and a V-convex shape and mounted on frame on frame arrangement;
a single filter rack configured to accommodate a predefined number of filter frame to overcome expected deflection of the at least three stage filter media.

2. The assembly as claimed in claim 1, wherein the filter frame is composed of a material comprising Plastic, Aluminum or pre-painted galvanized iron (PPGI).

3. The assembly as claimed in claim 1, wherein the filter frame is an air bypass leak proof frame.

4. The assembly as claimed in claim 1, wherein the filter rack comprises a plurality of mechanical clamps having a turn-key, wherein the plurality of clamps is configured to remove or fix the pre-filter individually without disturbing a filter from the at least three stage filter media.

5. The assembly as claimed in claim 1, wherein the fine filter media is adhered to filter frame using a chemical adhesive to withstand high air resistance.

6. The assembly as claimed in claim 1, wherein the pre-filter comprises at least one of a series of MERV-8 class air filters.

7. The assembly as claimed in claim 1, wherein the sigma convex shape is obtained by folding so as to create mountain folds and valley folds to lock the at least tree stage filter media with each other.

8. The assembly as claimed in claim 1, wherein the combined air pressure drop comprises a value of less than 1.5 inch wire gauge (WG) and a 70 percent less pressure drop against a panel type filter.

9. A method comprising:
providing a filter frame comprising at least one of a sigma ‘Σ’ convex shape and a V-convex shape, wherein providing a filter frame comprises accommodating at least two frames, using frame on frame design, to achieve maximum surface area and minimum air pressure drop;
accommodating at least three stage filter media inside the filter frame, wherein accommodating the at least three stage filter media comprising:
providing a pre-filter to filter coarse dust particles of a predefined size;
providing a carbon filter to eliminates formaldehyde, odors and volatile organic compounds in the air and improve air quality suitable for breathing;
providing a fine filter to remove bacteria, pollen, fine dust and aerosol of predetermined size from the air;
accommodating a predefined number of filter frame in a filter rack to overcome expected deflection of the at least three stage filter media.

10. The method as claimed in claim 10, wherein accommodating at least three stage filter media inside the filter frame comprises the at least one of a sigma convex shape and a V-convex shape of each of the at least three stage filter media and mounted on frame on frame arrangement.
